(19) United States
(12) Patent Application Publication
(10) Pub. No.: US 2016/0011989 A1
(43) Pub. Date: Jan. 14, 2016

(54) ACCESS CONTROL APPARATUS AND ACCESS CONTROL METHOD

(71) Applicant: FUJITSU LIMITED, Kawasaki-shi (JP)

(72) Inventors: Hidekazu TAKAHASHI, Kawasaki (JP); Miho Murata, Kawasaki (JP); Kazutaka OGIHARA, Hachioji (JP); Motoyuki Kawaba, Kawasaki (JP)

(73) Assignee: FUJITSU LIMITED, Kawasaki-shi (JP)

(21) Appl. No.: 14/790,522

(22) Filed: Jul. 2, 2015

(30) Foreign Application Priority Data
Jul. 8, 2014 (JP) 2014-140931
Jun. 25, 2015 (JP) 2015-128147

(51) Int. Cl. G06F 12/14; G06F 12/12

(52) U.S. Cl. CPC G06F 12/1425; G06F 12/121; G06F 2212/69; G06F 2212/1052

(57) ABSTRACT

An access control apparatus includes a processor. The processor is configured to receive an access request for accessing first data. The processor is configured to read consecutive blocks that start with a first block containing the first data from a first storage unit. The processor is configured to load the consecutive blocks as corresponding consecutive pages into a memory area. The processor is configured to invalidate the consecutive blocks in the first storage unit. The processor is configured to write, before the loading, some of first pages held in the memory area into a contiguous empty area of the first storage unit in accordance with an access status of each of the first pages. The access status is whether each of the first pages has been accessed.

### CROSS-REFERENCE TO RELATED APPLICATION

This application is based upon and claims the benefit of priority from the prior Japanese Patent Application No. 2015-128147 filed on Jun. 25, 2015, the entire contents of which are incorporated herein by reference.

### FIELD

The embodiments discussed herein are related to an access control apparatus and an access control method.

### BACKGROUND

As the speed of business increases in recent years, it is required to process a large amount of data arriving in a continuous stream in real time. Accordingly, a stream data processing technology of analyzing data immediately upon arrival of streaming data is attracting attention.

There exists a stream processing which analyses massive volume of data exceeding a permissible storage capacity in memory. In analysis processing, an access to a disk may be performed depending on the processing in order to process data having a size exceeding a permissible data size in a memory space.

Related techniques are disclosed in, for example, Japanese Laid-Open Patent Publication No. 10-31559, Japanese Laid-Open Patent Publication No. 2008-16024, and Japanese Laid-Open Patent Publication No. 2008-204041.

In order to achieve an efficient data access, a server may read in advance, in a memory area, blocks located in the vicinity of a block of a disk requested in a data access along with the requested block, in anticipation that the blocks in the vicinity of the requested block will also be accessed.

However, the blocks in the vicinity of the requested block are accessed only when the data access has relevance to a block placement in the disk. In a case where the data access has no sufficient relevance to the block placement in the disk, even though the blocks located in the vicinity of the block requested to be accessed are read in advance, the blocks read in advance are not actually accessed, thereby reducing a utilization efficiency of the memory area.

### SUMMARY

According to an aspect of the present invention, provided is an access control apparatus including a processor. The processor is configured to receive an access request for accessing first data. The processor is configured to read consecutive blocks that start with a first block containing the first data from a first storage unit. The processor is configured to load the consecutive blocks as corresponding consecutive pages into a memory area. The processor is configured to invalidate the consecutive blocks in the first storage unit. The processor is configured to write, before the loading, some of first pages held in the memory area into a contiguous empty area of the first storage unit in accordance with an access status of each of the first pages. The access status is whether each of the first pages has been accessed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating handling of a data block transferred between a memory and a disk in a data access;

FIG. 2 is a diagram illustrating a prefetch in a data access;

FIG. 3A is a diagram illustrating an event that may occur when a disk access occurs frequently;

FIG. 3B is a diagram illustrating an event that may occur when a disk access occurs frequently;

FIG. 4 is a diagram illustrating an exemplary access control apparatus according to an embodiment;

FIG. 5A is a diagram illustrating operations according to an embodiment;

FIG. 5B is a diagram illustrating operations according to an embodiment;

FIG. 5C is a diagram illustrating operations according to an embodiment;

FIG. 6A is a diagram illustrating data and a block according to an embodiment;

FIG. 6B is a diagram illustrating data and a block according to an embodiment;

FIG. 7 is a diagram illustrating an exemplary hardware configuration of a server according to an embodiment;

FIG. 8 is a diagram illustrating an example of physical layout management information according to an embodiment;

FIG. 9 is a diagram illustrating an example of a page management list according to an embodiment;

FIG. 10 is a diagram illustrating an operation flow of an IO execution unit according to an embodiment;

FIG. 11 is a diagram illustrating an operation flow of I/F “getitems_bulk(K,N)” according to an embodiment;

FIG. 12 is a diagram illustrating an operation flow of an IO size calculation unit according to an embodiment;

FIG. 13 is a diagram illustrating an example of update of a page management list when a block is requested according to an embodiment;

FIG. 14 is a diagram illustrating an example of update of a page management list after I/F “getitems_bulk(K,N)” is invoked according to an embodiment;

FIG. 15 is a diagram illustrating an operation flow of a page management unit according to an embodiment;

FIG. 16A is a diagram illustrating an operation flow of I/F “setitems_bulk(N)” according to an embodiment;

FIG. 16B is a diagram illustrating an operation flow of I/F “setitems_bulk(N)” according to an embodiment;

FIG. 17 is a diagram illustrating a case where blocks corresponding to pages indicated by four entries from a bottom of a page management list are selected as target blocks according to an embodiment;

FIG. 18A is a diagram illustrating an example of update of physical layout management information according to an embodiment;

FIG. 18B is a diagram illustrating an example of update of physical layout management information according to an embodiment; and

FIG. 19 is a block diagram illustrating an exemplary hardware configuration of a computer according to an embodiment.

### DESCRIPTION OF EMBODIMENT

In a stream processing of handling massive volume of data exceeding a permissible storage capacity in a memory, when a huge amount of data are arrived, a disk access frequently occurs such that the frequent disk access influences on a processing performance of a server in its entirety.

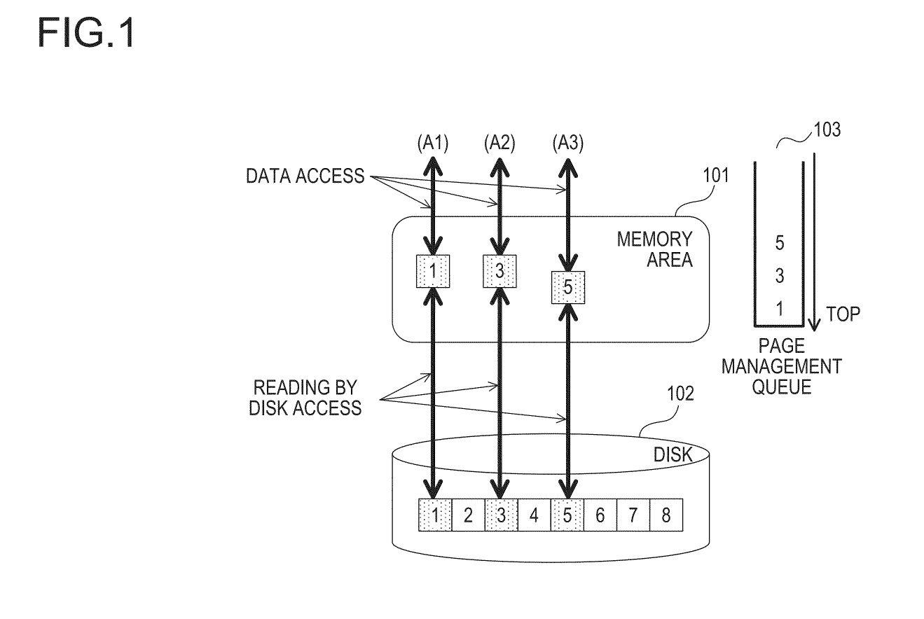

FIG. 1 is a diagram illustrating handling of a data block transferred between a memory and a disk in a data access. In FIG. 1, a disk 102 and a memory area 101 are illustrated. Here, a portion of a memory is assumed as the memory area 101. Regarding a page replacement algorithm for the memory area 101, for example, a least recently used (LRU) replacement scheme is used, in which a page which has not been referenced for the longest period of time in the memory area 101 is replaced.

In FIG. 1, a plurality of blocks having respective block identifiers (IDs) of #1, #2, #3, #4, #5, #6, #7, and #8 are placed on the disk 102. Note that, a block having a block ID of #n (n is an integer) is denoted by “block #n” in the specification, and “#” of each block ID is omitted in the drawings, for convenience. A block including data requested by a data access request is read and placed, as a page, on the memory area 101. For example, when a data access is requested for data included in the blocks #1, #3, and #5, the blocks #1, #3, and #5 are read from the disk 102 and pages corresponding to the read blocks #1, #3, and #5, respectively, are placed on the memory area 101. Note that, a page is identified by a block ID of a block corresponding to the page, and a page having a block ID of #n (n is an integer) is denoted by “page #n” in the specification.

When a page placed on the memory area 101 is intended to be replaced, a page (replacement page) to be replaced is determined by, for example, a page replacement algorithm.

In an LRU replacement scheme, a page which is held in the memory area 101 and has not been accessed for the longest period of time is chosen as a replacement page. A block corresponding to the replacement page is written back to, for example, the disk 102. The pages are managed by a page management queue 103 in a descending order of date and time of access to a page. For example, a page corresponding to accessed data is placed at the tail of the page management queue 103. As a result, pages corresponding to data which are not accessed longer time are placed to be nearer to the top of the page management queue 103. A page located at the top of the page management queue 103 is selected as a replacement page and the selected page is written back into, for example, the disk 102. In FIG. 1, the page management queue 103 illustrates a situation after data accesses occurred in the order of (A1), (A2) and (A3).

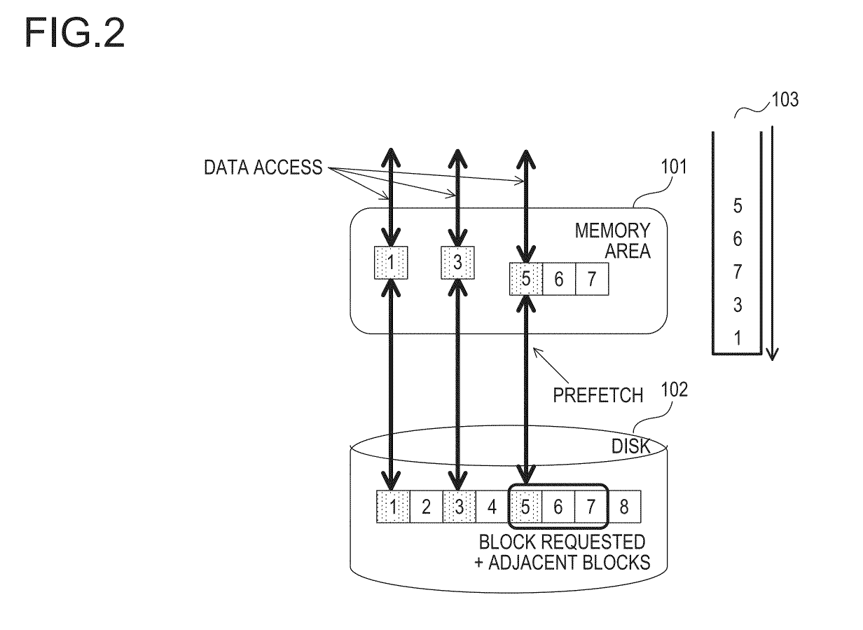

FIG. 2 is a diagram illustrating a prefetch in a data access. According to the present embodiment, a prefetch refers to a scheme in which a block on the disk 102 is read into the memory area 101 in advance. In FIG. 2, in a case where a page corresponding to a block requested in a data access is placed on the memory area 101, blocks located in the vicinity of the requested block in a physical placement are also accessed and placed in the memory area 101 along with the requested block. As described above, on the basis of a spatial locality at the time of reference, the pages corresponding to blocks located in the vicinity of a block requested to be accessed are placed in the memory area 101 in advance by a prefetch, even though the blocks are not requested to be accessed at that time.

The pages corresponding to the blocks which are not requested to be accessed at that time are also placed in the memory area 101 by a prefetch in order to reduce the number of accesses to the disk 102. However, when the pages placed in the memory area 101 along with the page corresponding to the requested block are replaced with other pages before being accessed, there is no effect of prefetch.

In FIG. 2, the page replacement algorithm page management queue 103 is in a situation after the block #5 and the adjacent blocks #6 and #7 placed in the disk 102 are accessed by a prefetch.

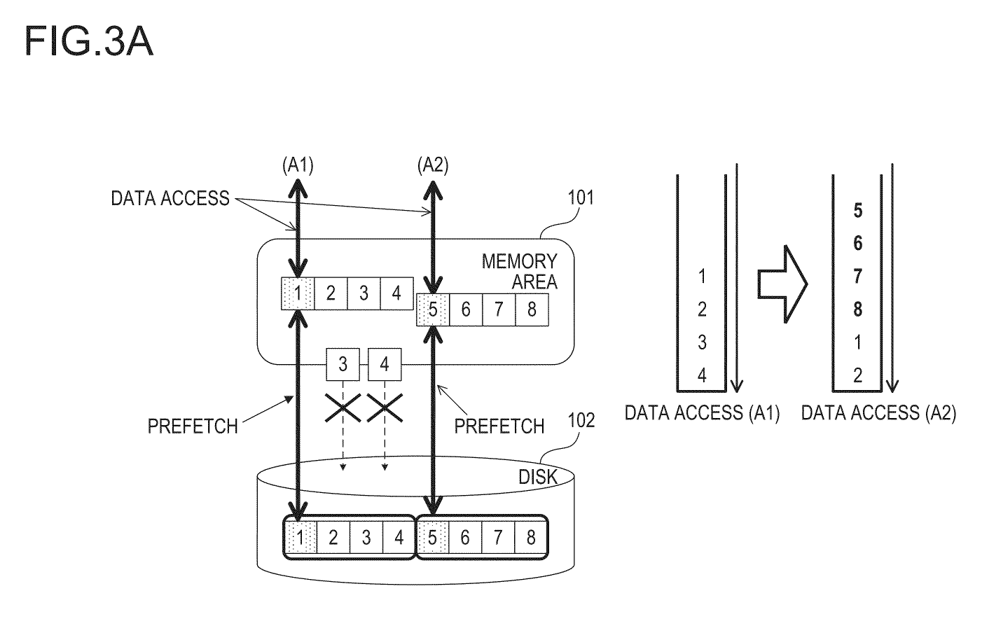

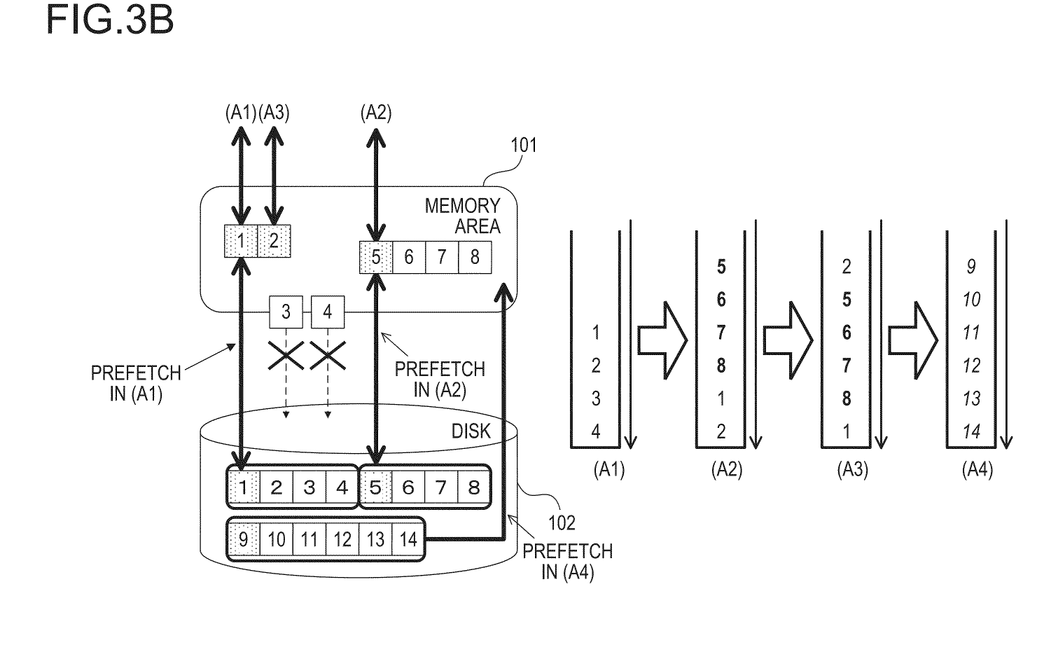

FIG. 3A and FIG. 3B are diagrams illustrating events that may occur when a disk access occurs frequently. In a situation where a disk access occurs frequently, writing back of data from the memory area 101 to the disk 102 by the page replacement algorithm frequently occurs due to a size limit of the memory area 101.

In FIG. 3A, when the block #1 and the adjacent blocks #2, #3, and #4 in the disk 102 are accessed by a prefetch for data access (A1), the pages #1, #2, #3, and #4 are placed in the memory area 101.

When the block #5 and the adjacent blocks #6, #7, and #8 in the disk 102 are accessed by a prefetch for data access (A2), the pages #5, #6, #7, and #8 are placed in the memory area 101. In this case, a page replacement occurs by a page replacement algorithm due to a size limit (e.g., 6 pages) of the memory area 101. As a result, since the pages #3 and #4 corresponding to the blocks #3 and #4 that are read in advance in data access (A1) have not yet been accessed, the pages #3 and #4 are to be replaced.

As the number of pages replaced without being accessed among the pages read in advance by prefetch increases, the utilization efficiency of the memory area 101 is reduced. That is, a situation where the pages corresponding to the blocks that are not accessed are placed (that is, useless reading) in the memory area 101 occurs. Therefore, the memory area 101 is occupied by the pages which are not accessed (reduction in utilization efficiency of the memory area). Further, when the number of pages replaced without being accessed among the pages read in advance by a prefetch increases, since the ratio of used blocks to the plurality of blocks read by a prefetch decreases, disk accesses are inefficiently performed.

For example, as illustrated in FIG. 3B, a case where data accesses (A1), (A2), (A3), and (A4) are made will be described. A prefetch is performed in data accesses (A1), (A2), and (A4). Among the pages #1, #2, #3, and #4 corresponding to the blocks prefetched in data access (A1), the accessed pages are the pages #1 and #2 and a ratio of used pages is 2/4. In the meantime, among the pages #5, #6, #7, and #8 corresponding to the blocks prefetched in data access (A2), the accessed page is the page #5 and a ratio of used pages is 1/4.

As described above, an effect by a prefetch is not obtained and also disk accesses are inefficiently performed (for example, four blocks are read for a single block and three of them are not used).

Accordingly, in the present embodiment, descriptions will be made on a technology of reducing the useless reading caused by a prefetch and improving the utilization efficiency of memory area.

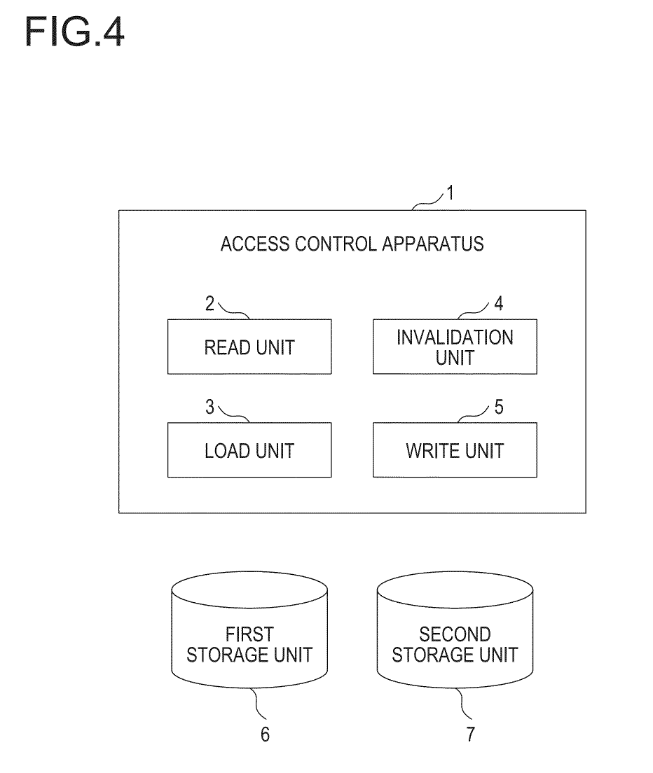

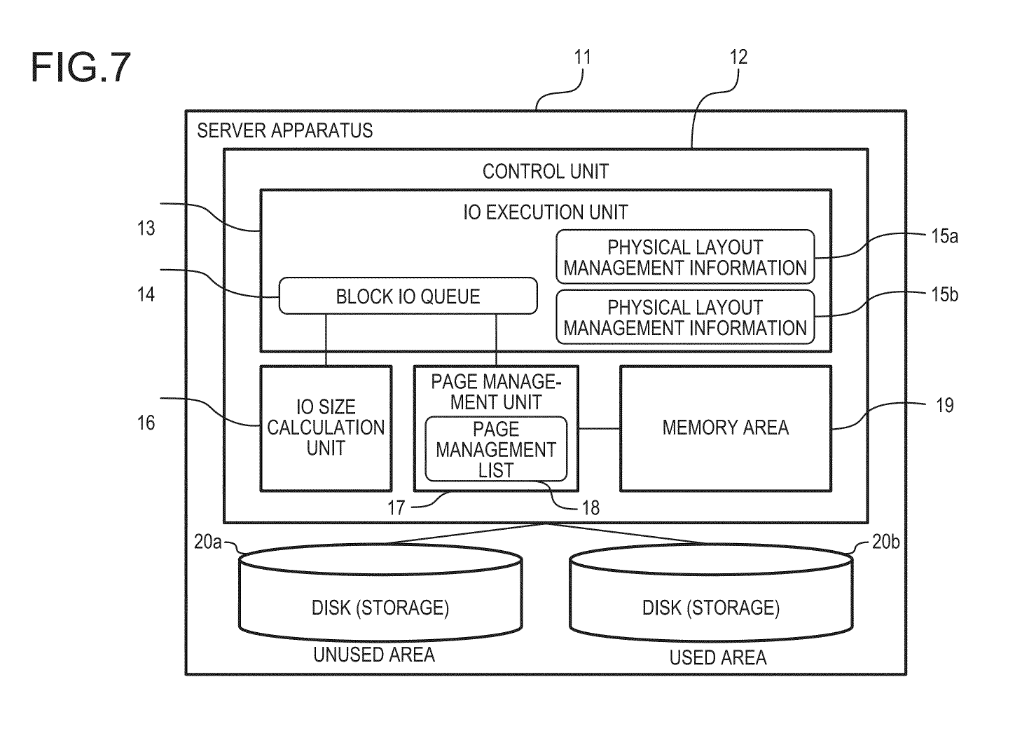

FIG. 4 is a diagram illustrating an exemplary access control apparatus according to the present embodiment. An access control apparatus 1 includes a read unit 2, a load unit 3, an invalidation unit 4, and a write unit 5. A control unit 12 (see FIG. 7) to be described later may be considered as an example of the access control apparatus 1.

The read unit 2 reads, in response to an access request for accessing first data, consecutive blocks that start with a first block containing the first data from a first storage unit 6 of which a storage area is managed in a block unit. An IO execution unit 13 (see FIG. 7) to be described later may be considered as an example of the read unit 2.

The load unit 3 loads the consecutive blocks into a memory area in which a storage area is managed in a page unit. The IO execution unit 13 may be considered as an example of the load unit 3.

The invalidation unit 4 invalidates the consecutive blocks in the first storage unit 6. The IO execution unit 13 may be considered as an example of the invalidation unit 4.

The write unit 5 writes pages, which are pushed out from the memory area due to the loading of the consecutive blocks into the memory area, to a contiguous empty area of the first storage unit 6 or a second storage unit 7, in which a storage area is managed in a block unit, according to an access status for the pages in the memory area. The write unit 5 writes the pages accessed in the memory area among the pushed out pages into the first storage unit 6. The write unit 5 writes the pages which are not accessed in the memory area among the pushed out pages into the second storage unit 7. A page management unit 17 (see FIG. 7) to be described later may be considered as an example of the write unit 5.

With the configuration as described above, the data used in the memory area may be collectively placed in a storage device for the used data. As a result, the utilization efficiency of data in a data access using a processing in which the data in the vicinity of the requested data are also read along with the requested data may be improved.

Hereinafter, the present embodiment will be described in detail. The present embodiment is executed by a control unit which implements a storage middleware functionality in, for example, a server apparatus (hereinafter, referred to as “server”). In reading a block from a disk, the server reads (prefetch) valid blocks located, in a physical area, in the vicinity of a block requested by a data access based on an application program, in addition to the requested block.

In the block read, the server executes a volatile read (in which the block which is read from the disk is deleted). The volatile read may contribute to securing a contiguous empty area on the physical region.

In writing a page into the disk, the server individually designates used pages (that is, pages for which access has been made) and unused pages (that is, pages for which access has not been made) using two lists.

When the storage middleware is activated, the server prepares a used area into which a block corresponding to a used page is written and an unused area into which a block corresponding to an unused page is written. When writing a block into the used area and the unused area, the block is added to the end of the written area in the used area and the unused area, respectively. Accordingly, the blocks corresponding to the used pages are collectively placed to achieve a reduction of the useless reading and improvement of the utilization efficiency of the memory area.

The server reads the block using the volatile read regardless of the used area and the unused area, and accesses a block including the requested data and a contiguous physical area in the vicinity of the block including the requested data.

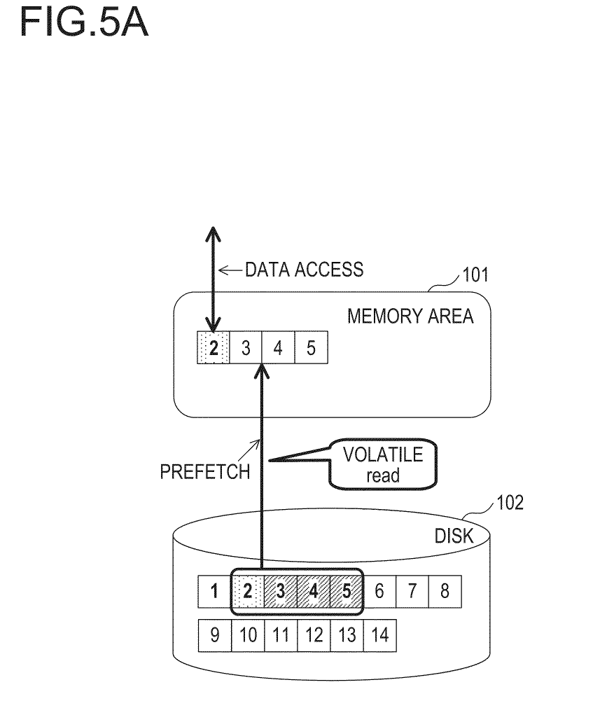

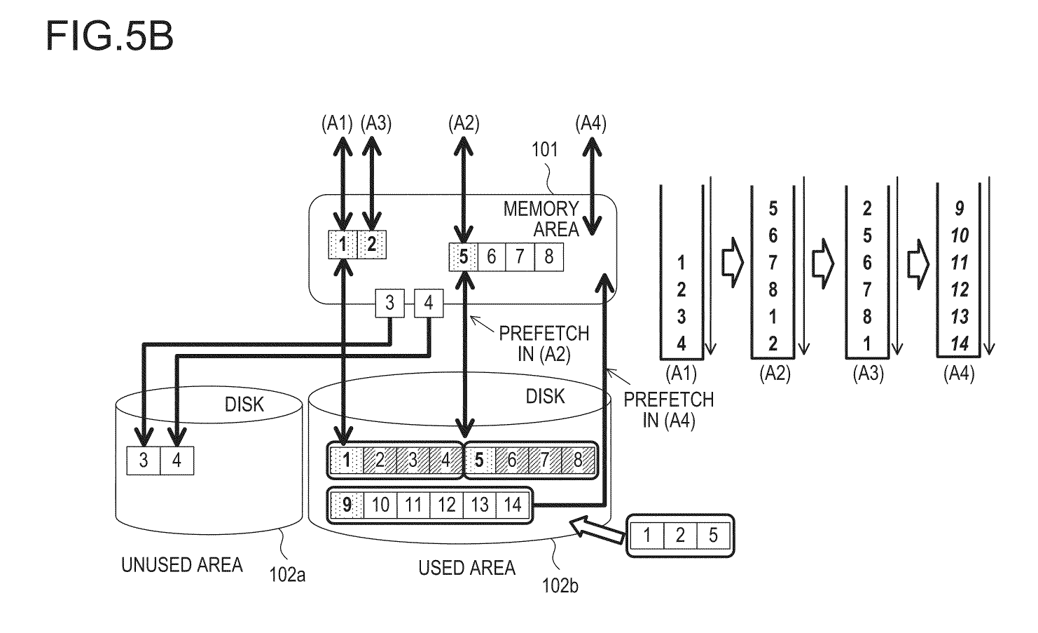

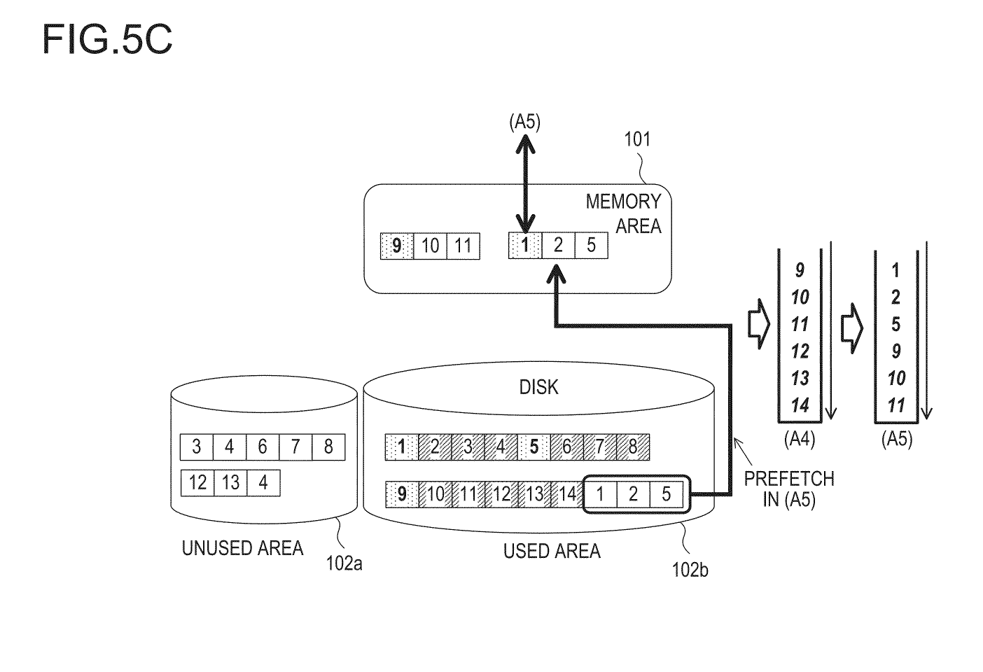

FIGS. 5A, 5B, and 5C are diagrams illustrating operations according to the present embodiment. In the present embodiment, an LRU method is utilized as an example of the page replacement algorithm. Further, the size limit on the memory area is set to, for example, 6 blocks.

As illustrated in FIG. 5A, in reading the block from the disk, the server accesses a block for which an access request is made and blocks located in the vicinity of the requested block by a prefetch. The server executes the volatile read to delete the blocks read in the disk access from the disk 102.

When writing back the pages held in the memory area 101 into the disk, as illustrated in FIGS. 5B and 5C, the server adds blocks corresponding to the used pages and blocks corresponding to unused pages to the respective areas (used area and unused area). Accordingly, since the blocks corresponding to the used pages are collectively placed, it is possible to reduce the useless reading and improve the utilization efficiency of the memory area.

For example, a case is considered where data accesses (A1) to (A5) are performed as in FIG. 5B and FIG. 5C. In data access (A1), when blocks #1, #2, #3, and #4 are prefetched, the blocks #1, #2, #3, and #4 are deleted from a disk 102b and the block IDs of #1, #2, #3, and #4 are stored in the page management queue 103.

In data access (A2), when blocks #5, #6, #7, and #8 are prefetched, the blocks #5, #6, #7, and #8 are deleted from the disk 102b and the block IDs of #5, #6, #7, and #8 are stored in the page management queue 103. At this time, some pages are written back into the disk due to the size limit of the memory area 101. Since the pages #3 and #4 among the pages prefetched in data access (A1) are unused pages (pages which have not been accessed), the pages #3 and #4 are written back into a disk 102a in which the unused area is prepared.

In data access (A3), an access to the page #2 held in the memory area 101 is made and an order of the block IDs held in the page management queue 103 is updated. In data access (A4), when blocks #9, #10, #11, #12, #13, and #14 are prefetched, the blocks #9, #10, #11, #12, #13, and #14 are deleted from the disk 102b and the block IDs of #9, #10, #11, #12, #13, and #14 are stored in the page management queue 103. At this time, some pages are written back into the disk due to the size limit on the memory area 101. Since the pages #6, #7 and #8 among the pages having the block IDs held in the page management queue 103 have not been used (not accessed), the pages #6, #7 and #8 are written back into the disk 102a in which the unused area is prepared. On the other hand, since the pages #1, #2, and #5 among the pages having the block IDs held in the page management queue 103 have been used (accessed), the pages #1, #2, and #5 are written back into the disk 102b in which the used area is prepared.

In data access (A5), when the blocks #1, #2, and #5 are prefetched, the blocks #1, #2, and #5 are deleted from the disk 102b and the block IDs of #1, #2, and #5 are stored in the page management queue 103. At this time, some pages are written back into the disk due to the size limit on the memory area 101. Among the pages having the block IDs held in the page management queue 103, the pages #12, #13, and #14 that have not been used (not accessed) are written back into the disk 102a in which the unused area is prepared.

According to the present embodiment, the blocks corresponding to the used pages are collectively placed in the disk. As a result, the useless reading by a prefetch is reduced and the utilization efficiency of the memory area is improved. Further, it is possible to make an efficient prefetch compatible with a high speed access for the memory area.

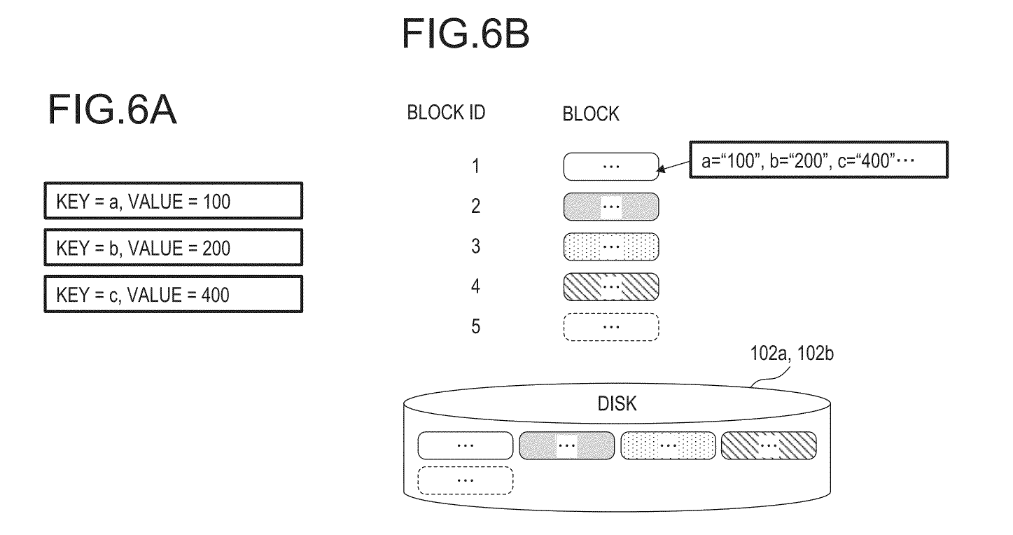

Hereinafter, the present embodiment will be described in more detail. FIG. 6A and FIG. 6B are diagrams illustrating data and blocks according to the present embodiment. The data is a pair of a key and a value as illustrated in FIG. 6A. The block is a management unit managed by an address in the disks 102a and 102b. The data is stored in the disks 102a and 102b in a block unit as illustrated in FIG. 6B. A plurality of pairs of data are included in a single block.

A block and a page corresponding to the block are identified by a block ID. The block ID may be designated to perform a block read.

FIG. 7 illustrates an exemplary hardware configuration of a server according to the present embodiment. A server apparatus 11 includes a control unit 12 and disks (storage) 20 (20a and 20b). By reading a program from a storage device (not illustrated) and executing the program, the control unit 12 implements a storage middleware functionality of reading and writing data from and to the disks 20.

When the storage middleware is activated, an unused area is prepared in the disk 20a and a used area is prepared in the disk 20b. The unused area is an area in which blocks corresponding to the unused pages are written. The used area is an area in which blocks corresponding to the unused pages are written. The unused area and the used area may be prepared in either a single disk or different disks.

As examples of interfaces (I/Fs) for input/output (IO) in the storage middleware, there are “getitems_bulk(K,N)” and “setitems_bulk(N)”.

The control unit 12 uses the “getitems_bulk(K,N)” as an I/F for reading blocks from the disk to the memory area. K is a block ID of a block requested to be read. The control unit 12 collectively reads (prefetch) the block corresponding to the key K and blocks located in the vicinity of the block in the physical placement on the disk. N is an IO size to be described later. The IO size indicates a range (may be either a size of data or a number of pieces of data) designating the vicinity of the block to be accessed in the physical placement, and an area in the vicinity of the block to be accessed indicated by the designated range is accessed. In the present embodiment, the IO size is designated by the number of blocks.

The control unit 12 uses the “setitems_bulk(N)” as an I/F for writing blocks from the memory area into the disk. The control unit 12 designates the IO size N. The “setitems_bulk(N)” determines, based on the IO size N, blocks to be written. The “setitems_bulk(N)” divides the to-be-written blocks into used blocks that have been used and unused blocks that have not been used. The “setitems_bulk(N)” writes the used blocks and the unused blocks into the used area and the unused area, respectively.

The control unit 12 includes an IO execution unit 13, an IO size calculation unit 16, a page management unit 17, and a memory area 19.

The IO execution unit 13 executes a block read which accesses blocks on the disks 20 in response to a data access (read access or write access) request based on an application program.

The IO execution unit 13 includes a block IO queue 14 and physical layout management information 15 (15a and 15b). The block IO queue 14 is a queue in which a block ID of the requested block is stored.

The physical layout management information 15 (15a and 15b) manages valid/invalid of blocks on the disks 20a and 20b, respectively, and block addresses of the blocks. The physical layout management information 15a is physical layout management information related to the disk 20a designated for being used as the unused area. The physical layout management information 15b is physical layout management information related to the disk 20b designated for being used as the used area.

The IO execution unit 13 executes the “getitems_bulk(K,N)” to perform a block read. When an access request for accessing a block is made based on the application program, the IO execution unit 13 stores a block ID of the requested block into the block IO queue 14 and sequentially extracts the block ID from the block IO queue 14 to execute the access request.

At this time, the IO execution unit 13 invokes the IO size calculation unit 16 and acquires the number N of blocks to be read. N is a value determined based on a length L of the block IO queue 14 and an IO size N′ calculated in the last block read request, and the value is equal to or greater than 1 (one).

In the case of a block read, the IO execution unit 13 extracts a block ID from the top of the block IO queue 14, acquires a block address with reference to the physical layout management information 15, and accesses the disks 20a and 20b on the basis of the acquired block address.

At this time, the IO execution unit 13 accesses a block having a block ID designated by K. Further, the IO execution unit 13 accesses blocks in the vicinity of the block in the physical placement on the disks 20 in accordance with the number designated by N, and returns valid blocks among the accessed blocks on the basis of the physical layout management information 15.

The IO execution unit 13 normally performs a non-volatile read (a block to be read is not deleted from the disk) at the time of the block read and a volatile read when a filling rate is lower than a threshold value.

Before reading the block, the IO execution unit 13 references the physical layout management information 15 to calculate the filling rate and selects, on the basis of the filling rate, whether to perform the volatile read or the non-volatile read.

The IO execution unit 13 invalidates a block on the physical layout management information 15 when deleting the block in a case where the volatile read is performed.

The IO execution unit 13 executes the “setitems_bulk(N)” to write back the number of blocks designated by N among the blocks corresponding to the pages on the memory area 19 into the disk. At this time, the IO execution unit 13 classifies the blocks corresponding to the pages on the memory area 19 into the used blocks to be designated in the [used_key_value_list] and the unused blocks to be designated in the [unused_key_value_list] in accordance with information of the reference counter of a page management list 18 to be described later.

Regarding the blocks designated in the [unused_key_value_list], the IO execution unit 13 references the physical layout management information 15 before writing the block into the disk 20a to determine which has been performed, the volatile read or the non-volatile read. That is, the IO execution unit 13 references the physical layout management information 15 to determine whether the block has been read by the volatile read or the non-volatile read, by determining whether the corresponding block is invalidated or not.

When the block designated in the [unused_key_value_list] has been read by the non-volatile read, the IO execution unit 13 does not write the block into the disk 20a. When the block designated in the [unused_key_value_list] has been read by the volatile read, the IO execution unit 13 adds the block to the disk 20a.

The IO execution unit 13 invalidates the block designated in the [used_key_value_list] and adds the block to the disk 20b.

When the block to be added to the disks 20 is determined, the IO execution unit 13 updates the physical layout management information 15 and adds the determined block to the disks 20. The IO execution unit 13 deletes the blocks designated in the [unused_key_value_list] or the [used_key_value_list] from the page management list 18 whether the blocks are to be added or not.

The IO size calculation unit 16 calculates an IO size N (which equals to the number of blocks to be read) on the basis of a number (hereinafter, queue length L) of requested block IDs stored in the block IO queue 14 and an IO size N′ calculated in the last block read request and returns the calculated IO size.

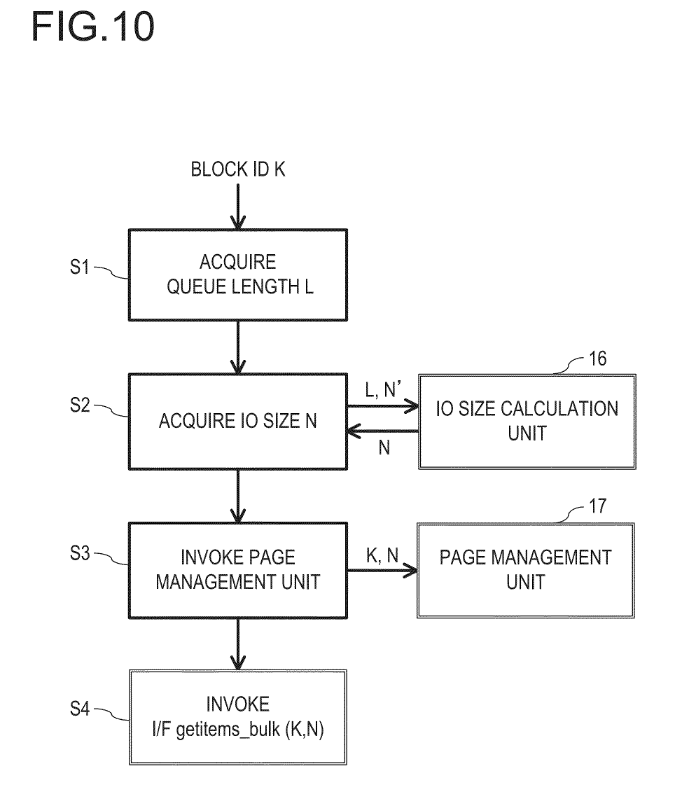

The page management unit 17 holds the page management list 18. Details of the processing performed by the page management unit 17 will be described later with reference to FIG. 10. The page management list 18 is used for managing the number of times of referencing each block and the blocks that are most recently accessed.

The page management list 18 has, for each block, an entry including a block ID and a reference counter. When a block read is requested, the page management unit 17 counts up a reference counter included in an entry of the page management list 18 corresponding to the block requested to be read and moves the entry to the top of the page management list 18.

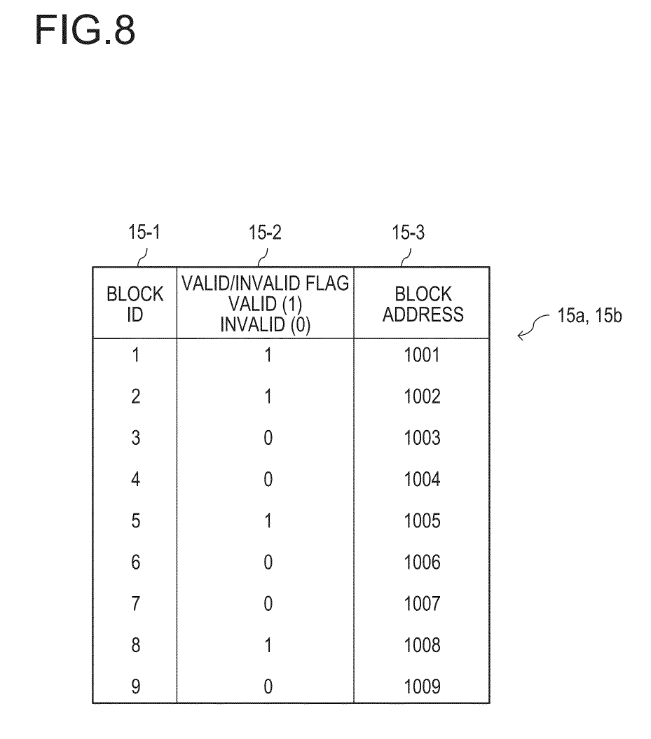

FIG. 8 illustrates an example of physical layout management information according to the present embodiment. As described above, the physical layout management information 15a is the physical layout management information about the disk 20a designated for being used as the unused area. The physical layout management information 15b is the physical layout management information about the disk 20b designated for being used as the used area. A data structure of the physical layout management information 15a is the same as a data structure of the physical layout management information 15b. Each entry of the physical layout management information 15a and 15b includes data items for “block ID” 15-1, “valid/invalid flag” 15-2, and “block address” 15-3.

In the data item of “block ID” 15-1, a block ID identifying a block on the disks 20a and 20b is stored. In the data item of “valid/invalid flag” 15-2, flag information indicating whether the block indicated by the block ID is valid (“1”) or invalid (“0”) is stored. In the data item of “block address” 15-3, an address, on the disks 20a and 20b, of the block indicated by the block ID is stored.

The IO execution unit 13 reads a block ID sequentially from the top of the block IO queue 14. The IO execution unit 13 references the physical layout management information 15a and 15b to acquire a block address for the block ID read from the block IO queue 14. The IO execution unit 13 accesses the address on the disks 20a and 20b indicated by the acquired block address.

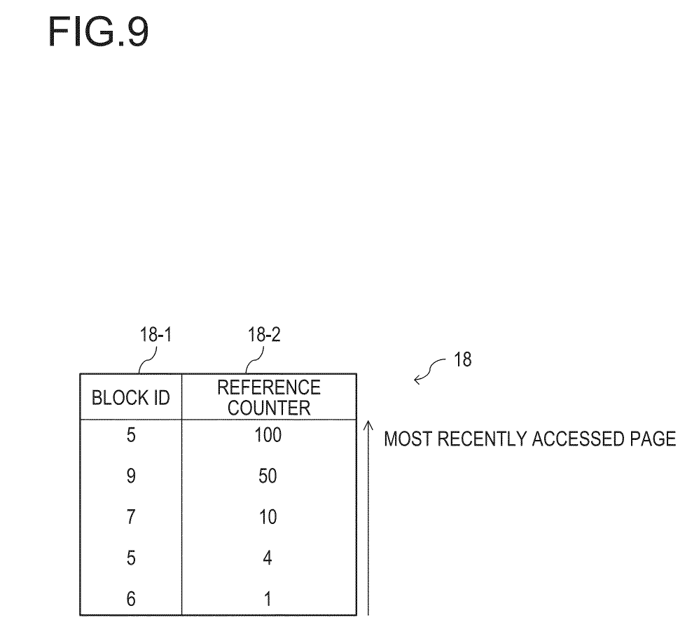

FIG. 9 illustrates an example of a page management list according to the present embodiment. Each entry of the page management list 18 includes data items for “block ID” 18-1 and “reference counter” 18-2. In the data item of “block ID” 18-1, a block ID identifying a block corresponding to a page placed in the memory area 19 is stored. In the data item of “reference counter” 18-2, the number of times of referencing the page corresponding to the block identified by the block ID is stored.

In the page management list 18, pages that are accessed more recently are stored more nearer to the top of the list.

FIG. 10 illustrates an operation flow of an IO execution unit according to the present embodiment. The IO execution unit 13 sequentially reads a block ID (it is assumed to be K, for example) stored in the block IO queue 14 from the top of the block IO queue 14 and acquires the number (hereinafter, referred to as a queue length L) of requested block IDs stored in the block IO queue 14 (S1).

The IO execution unit 13 invokes the IO size calculation unit 16 and acquires an IO size N (number of blocks to be read) (S2). The IO size calculation unit 16 determines the IO size N on the basis of the queue length L of the block IO queue 14 and the IO size N′ calculated in the last block read request. A threshold value is set for the queue length L in advance. An initial value of N is set to 1 (one) and when L exceeds the threshold value, the value of N is set to, for example, a value obtained by multiplying N′ by 2 (two) as a new value of N, that is, the value of N increases as 1, 2, 4, 8 . . . , for example. When L is lower than the threshold value, N is set to half thereof, that is, the value of N decreases as 8, 4, 2, 1, for example. The minimum value of N is set to 1 (one) and the maximum value of N is set to a predetermined value (for example, 64).

The IO execution unit 13 invokes the page management unit 17 (S3). The page management unit 17 starts to write less frequently accessed pages from the memory area to the disk as needed. In a case where the memory area is full, the page management unit 17 writes back pages of the IO size among the pages held in the memory area to the disk before reading the requested blocks. The pages to be written back to the disk are pages identified by block IDs of the IO size (N blocks) held in the bottom of the page management list 18. At this time, the page management unit 17 classifies blocks corresponding to the pages into blocks corresponding to the used pages and blocks corresponding to the unused pages in accordance with the value of the reference counter. A block having a reference counter value of 0 (zero) is a block corresponding to the unused page and a block having a reference counter value larger than 0 is a block corresponding to the used page.

The IO execution unit 13 invokes the I/F “getitems_bulk(K,N)” (S4). The IO execution unit 13 accesses a block corresponding to the designated block ID K and also accesses blocks in the vicinity of the block having the designated block ID K in the physical placement of the disks 20 in accordance with the IO size (number of blocks to be read). The IO execution unit 13 returns valid blocks among the accessed blocks.

The IO execution unit 13 acquires a block address of the block corresponding to the designated block ID K from the physical layout management information and accesses the block stored in the disk. As described above, there are two pieces of physical layout management information corresponding to the used blocks and the unused blocks, respectively. The IO execution unit 13 searches two pieces of physical layout management information 15a and 15b for the block address.

The IO execution unit 13 performs the volatile read at the time of the block read. That is, the IO execution unit 13 handles the read block in the same manner as the block deleted from the disk. That is, the IO execution unit 13 invalidates the read block in the physical layout management information 15a and 15b.

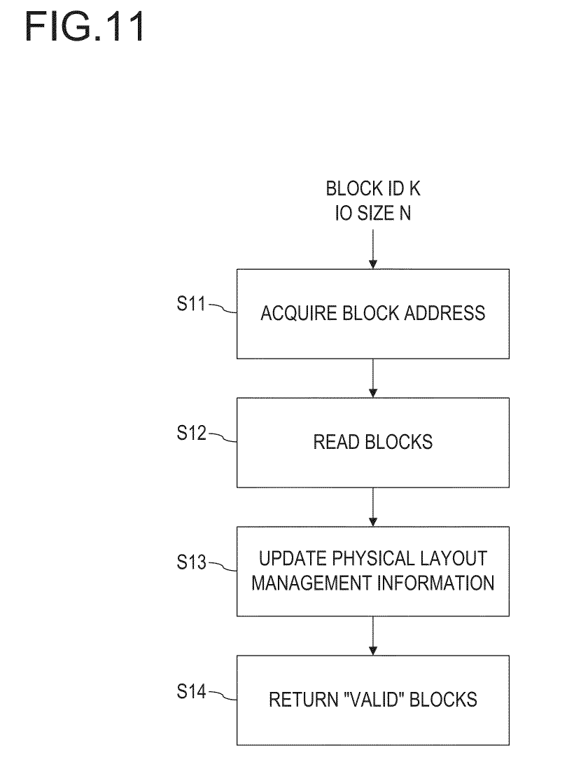

FIG. 11 illustrates an operation flow of the I/F “getitems_bulk(K,N)” according to the present embodiment. The requested block ID K and the IO size N are passed to the invoked “getitems_bulk(K,N)” as input parameters.

The IO execution unit 13 searches the physical layout management information 15a and 15b using the requested block ID K as a key and acquires the block address corresponding to the block ID K (S11). For example, when the requested block ID is “#1”, a block address “1001” is acquired from the physical layout management information illustrated in FIG. 8.

The IO execution unit 13 reads blocks having block IDs K to K+N−1 (K and N are integers) from the disk 20a or the disk 20b using the volatile read scheme (S12).

The IO execution unit 13 updates valid/invalid flags of the read blocks to “0” (invalid) in the physical layout management information 15a or the physical layout management information 15b in order to invalidate the blocks read at S12 (S13).

The IO execution unit 13 returns valid blocks read at S12 (S14). That is, the IO execution unit 13 returns blocks for which the valid/invalid flag is set to “1” (valid) in the physical layout management information 15a or 15b before being updated at S13 among the blocks read at S12. The IO execution unit 13 stores the read valid blocks in the memory area 19.

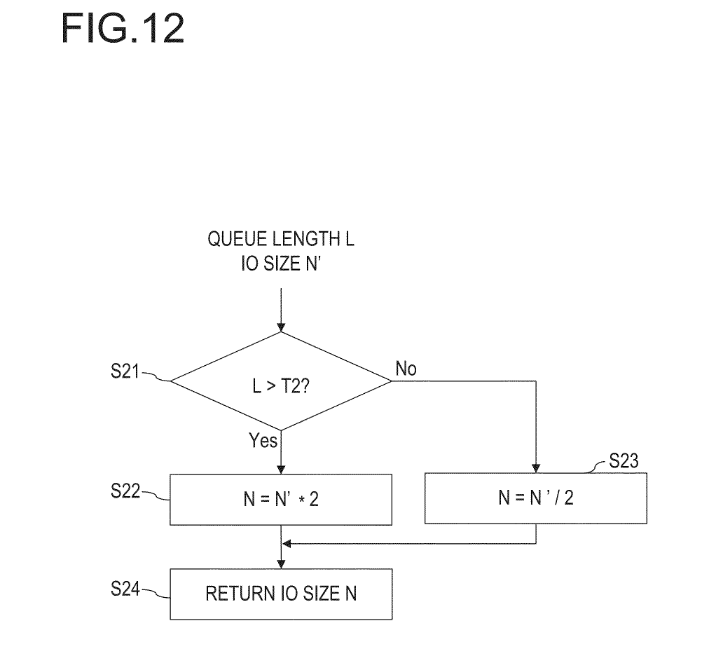

FIG. 12 illustrates an operation flow of an IO size calculation unit according to the present embodiment. The IO size calculation unit 16 invoked by the IO execution unit 13 at S2 of FIG. 10 executes the flow of FIG. 12. The IO size calculation unit 16 receives the queue length L and the IO size N′ calculated at previous time as input parameters from the IO execution unit 13.

The IO size calculation unit 16 compares the queue length L with the threshold value T2 (S21). The threshold value T2 is set in the storage unit in advance. When the queue length L is larger than the threshold value T2, the IO size calculation unit 16 sets a value calculated by multiplying N′ by 2 (two) as N (S22). Here, the maximum value of N is set in advance. The maximum value of N is set to, for example, 64 and N is not set to a value larger than 64.

When the queue length L is equal to or less than the threshold value T2, the IO size calculation unit 16 sets a value calculated by dividing N′ by 2 (two) as N (S23). Here, the minimum value of N is set to 1 and N is not set to a value less than 1.

The IO size calculation unit 16 returns the calculated IO size N to the IO execution unit 13 (S24).

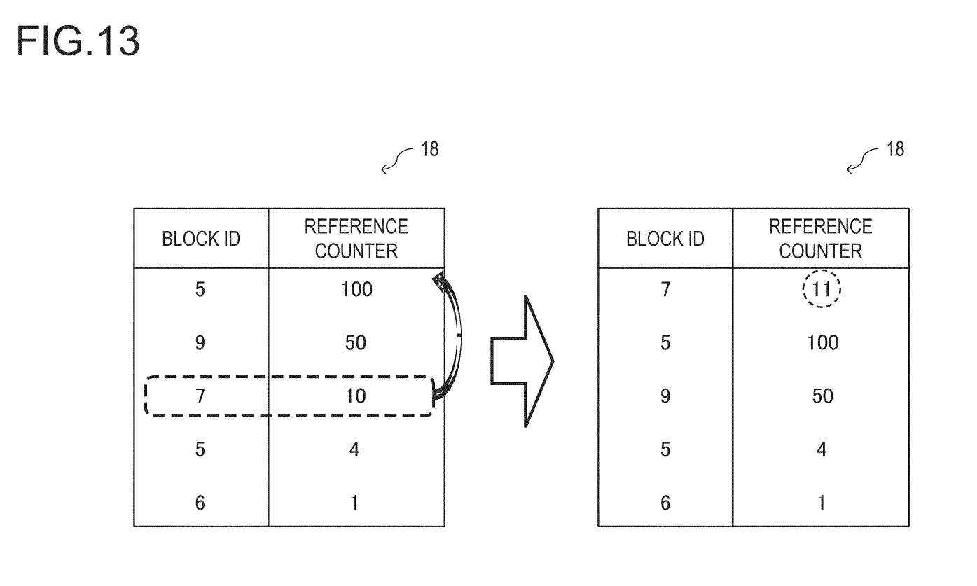

FIG. 13 illustrates an example of update of a page management list when a block having a block ID of #7 is requested according to the present embodiment. When the block having the block ID of #7 is requested, the page management unit 17 increments the reference counter for the block ID of #7 in the page management list 18, and moves the entry including the block ID of #7 to the top of the page management list 18.

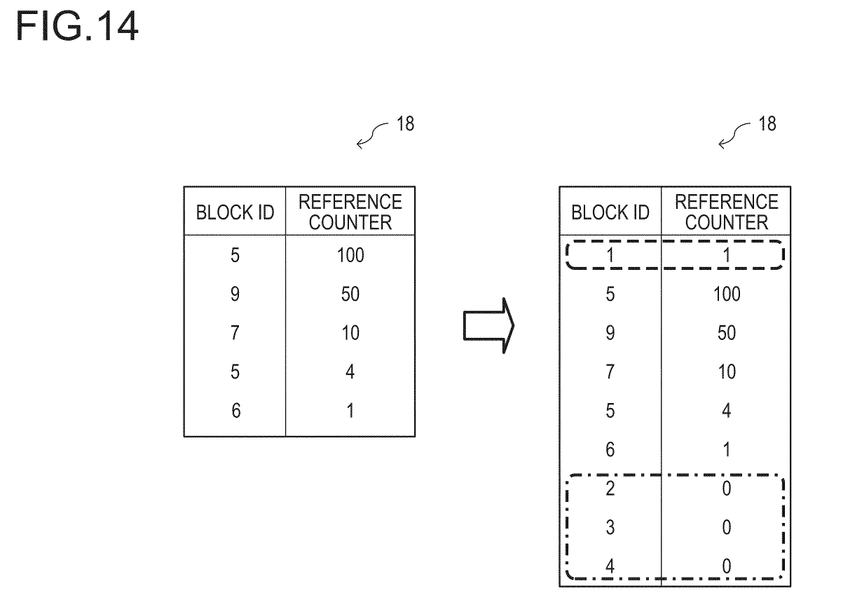

FIG. 14 illustrates an example of update of the page management list after the I/F “getitems_bulk(K,N)” is invoked according to the present embodiment. In FIG. 14, descriptions will be made on a case where the I/F “getitems_bulk(#1,4)” is invoked, in which a block ID of the requested block is #1 and the IO size N is 4, and blocks having block IDs of #1, #2, #3, and #4 are read.

The page management unit 17 places an entry including the block ID of #1 and a reference counter of “1” for the page corresponding to the requested block at the top of the page management list 18. Further, the page management unit 17 places entries including the respective block IDs of #2, #3, and #4 and a reference counter of “0” for the pages corresponding to the blocks in the bottom of the page management list 18, which are read by a prefetch of the IO size 4 and are not requested.

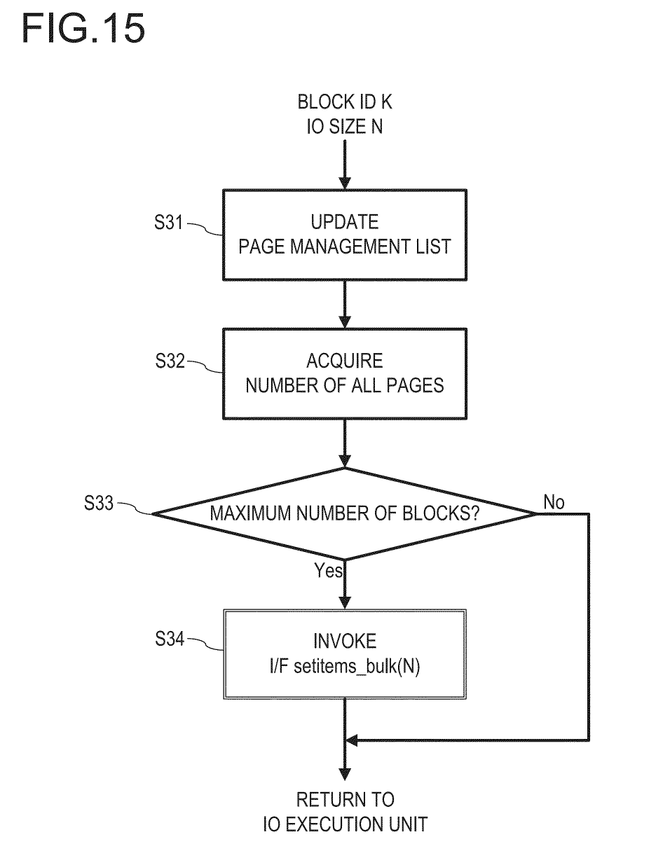

FIG. 15 illustrates an operation flow of a page management unit according to the present embodiment. The page management unit 17 invoked by the IO execution unit 13 at S3 of FIG. 10 executes the flow of FIG. 15. The page management unit 17 receives the requested block ID K and the IO size N as input parameters from the IO execution unit 13.

The page management unit 17 updates the page management list 18 for the requested block having the block ID K as described with reference to FIG. 13 and FIG. 14 (S31).

The page management unit 17 acquires the number of all pages held in the memory area, that is, the number of all entries registered in the page management list 18 (S32).

When the number of pages acquired at S32 equals to the maximum number of blocks that may be held in the memory area 19 (YES at S33), the page management unit 17 performs the following processing. That is, the page management unit 17 invokes the I/F “setitems_bulk(N)” (S34).

At the time of addition of data, the processing of (1) addition of blocks, (2) update of the physical layout management information (the added block is made valid), (3) update of the page management list are performed.

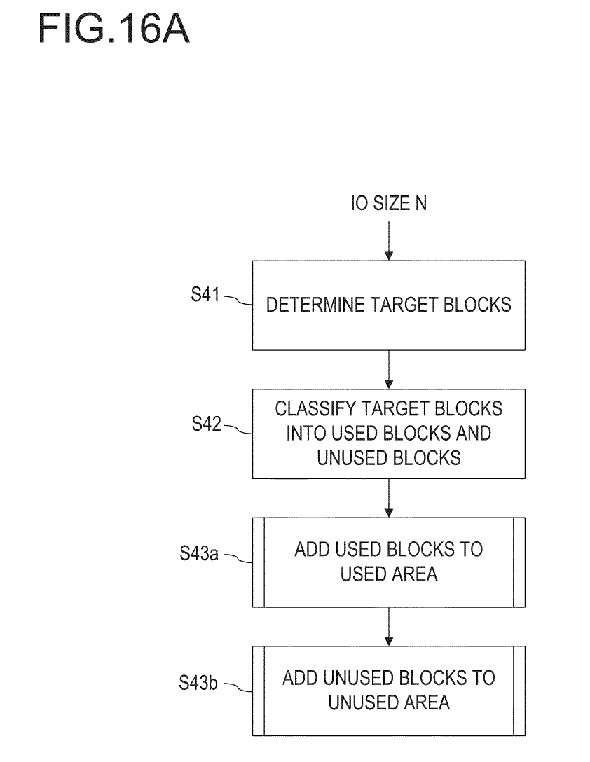

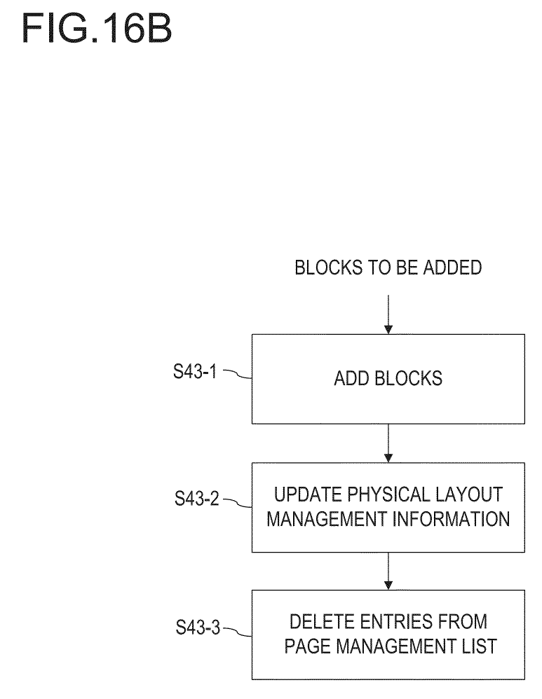

FIG. 16A and FIG. 16B illustrate an operation flow of the I/F “setitems_bulk(N)” according to the present embodiment. The IO size N is passed as an input parameter to the I/F “setitems_bulk(N)” invoked by the page management unit 17.

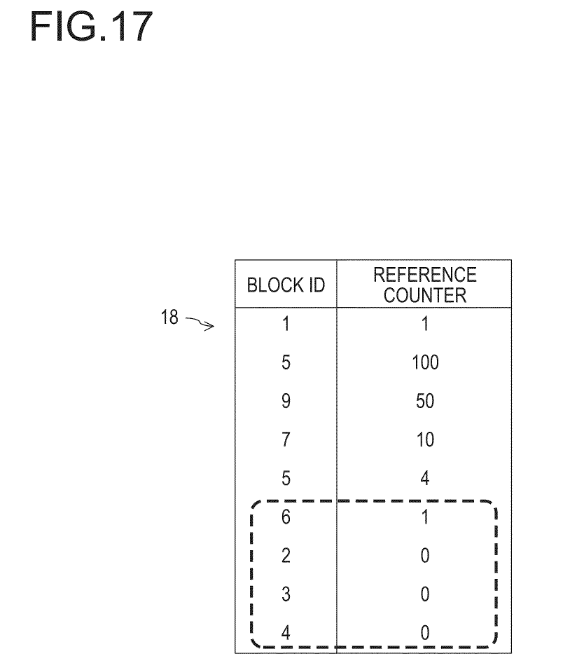

The page management unit 17 references the page management list 18 to determine target blocks (S41). Here, the page management unit 17 selects blocks of the IO size N from the bottom of the page management list 18 as the target blocks. For example, when N equals to 4, as illustrated in FIG. 17, four blocks corresponding to the pages indicated by four entries from the bottom of the page management list 18 are selected as the target blocks.

The page management unit 17 classifies the target blocks selected at S41 into blocks corresponding to used pages and blocks corresponding to unused pages on the basis of the value of the reference counter (S42). A block corresponding to a page having a value 0 (zero) in the reference counter is determined as a block corresponding to an unused page, and a block corresponding to a page having a value larger than 0 (zero) in the reference counter is determined as a block corresponding to a used page. In FIG. 17, a block having a block ID of #6 is a used block and blocks having block IDs of #2, #3, and #4 are unused blocks.

The page management unit 17 adds used blocks to the used area (S43a) and adds unused blocks to the unused area (S43b). Details of the processing of S43A and S43b are illustrated in FIG. 16B.

When the target block to be added is a used block, the page management unit 17 adds the target used block to the used area. When the target block to be added is an unused block, the page management unit 17 adds the target unused block to the unused area (S43-1).

When the target block to be added is a used block, the page management unit 17 adds the target used block to an empty area next to the last area in which a valid block is placed in the used area prepared in the disk 20b at S43-1. That is, the page management unit 17 writes m blocks into physically contiguous empty areas in which m blocks are not placed and which follow a physical end of a storage area in which blocks are written in the disk 20b. Here, the m (m is an integer) blocks are a group of blocks classified as used blocks at S42.

When the target block to be added is an unused block, the page management unit 17 adds the target unused block to an empty area next to the last area in which a valid block is placed in the unused area prepared in the disk 20a at S43-1. That is, the page management unit 17 writes m blocks into physically contiguous empty areas in which m blocks are not placed and which follow a physical end of storage area in which the blocks are written in the disk 20a. Here, the m (m is an integer) blocks are a group of blocks classified as unused blocks at S42.

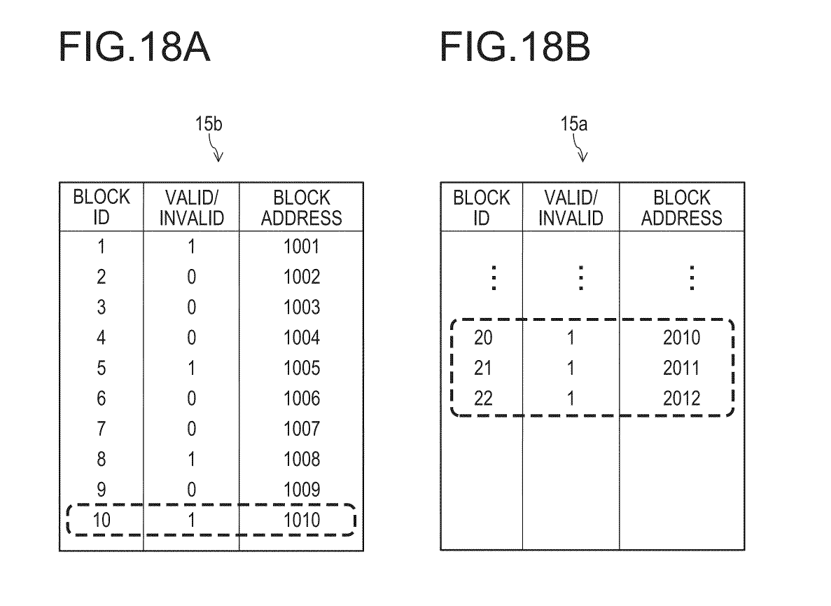

The page management unit 17 updates the physical layout management information 15b and the physical layout management information 15a for the used blocks and the unused blocks, respectively (S43-2). Descriptions will be made later on the update of the physical layout management information with reference to FIG. 18A and FIG. 18B.

The page management unit 17 deletes entries for the pages corresponding to the target blocks to be added from the page management list 18 (S43-3). The page management unit 17 deletes the entries for the pages corresponding to the target blocks (unused blocks and used blocks) determined at S41 from the page management list 18. In the case of FIG. 17, four entries (entries surrounded by a broken line) from the bottom of the page management list 18 are deleted.

FIG. 18A and FIG. 18B illustrate examples of an update of the physical layout management information 15b and the physical layout management information 15a according to the present embodiment. It is assumed that the blocks having the block IDs of #2, #3, #4, and #6 are placed in the used area before the physical layout management information 15b and the physical layout management information 15a are updated.

For example, when the used block to be added is the block having the block ID of #6 as illustrated in FIG. 17, the page management unit 17 newly adds an entry of block having a block ID of #10 to the end of the physical layout management information 15b as a block corresponding to the older block having the block ID of #6 as illustrated in FIG. 18A. At this time, the valid/invalid flag of the added entry is set as “1” (valid).

Further, for example, when the unused blocks to be added are the blocks having the block IDs of #2, #3, and #4 as illustrated in FIG. 17, the page management unit 17 newly adds entries of blocks having the block IDs of #20, #21, and #22 to the end of the physical layout management information 15a as blocks corresponding to the older blocks having the block IDs of #2, #3, and #4 as illustrated in FIG. 18B. At this time, the valid/invalid flags of the added entries are set as “1” (valid).

According to the present embodiment, blocks corresponding to the used pages are collectively placed on a storage area of a disk. As a result, the useless reading by a prefetch is reduced and the utilization efficiency of the memory area is improved. Further, it is possible to achieve a compatibility of an efficient prefetch with high speed access for the memory.

According to the present embodiment, in a case where a page is written back from the memory area to the disk, a block is added to an empty area (or invalidated area) next to the last area in which the valid block is placed in the disks 20a and 20b, but embodiments are not limited thereto. For example, when an empty area (or invalidated area) having a size equal to or greater than the size of the target blocks to be added exists in the disk, the target blocks to be added may be sequentially written into the areas next to a valid block located immediately ahead of the empty area.

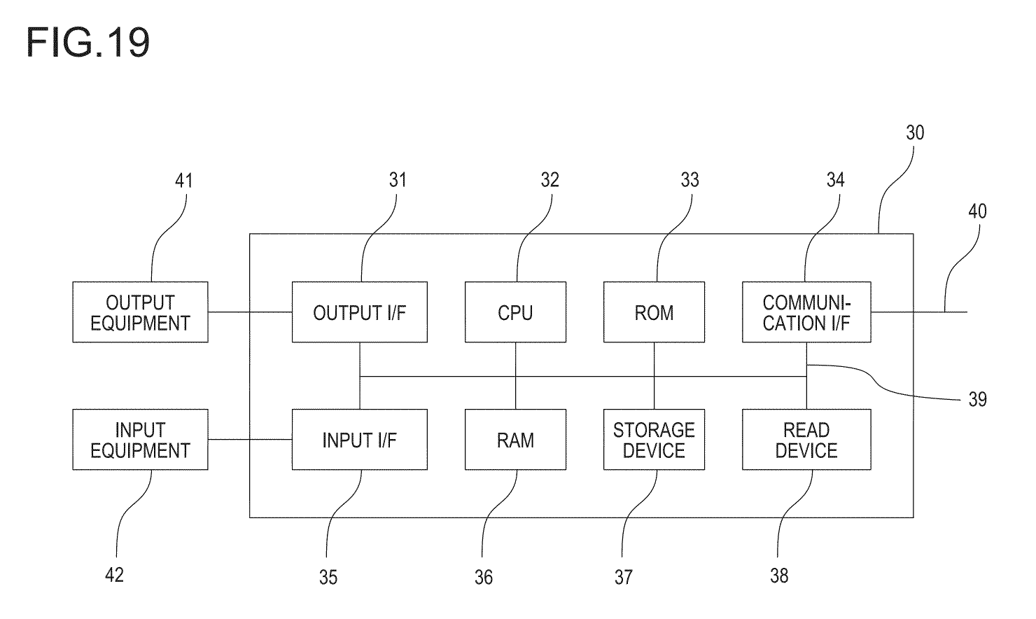

FIG. 19 is a block diagram illustrating an exemplary hardware configuration of a computer according to the present embodiment. A computer 30 functions as the server apparatus 11. The computer 30 includes, for example, a central processing unit (CPU) 32, a read-only memory (ROM) 33, a random access memory (RAM) 36, a communication I/F 34, a storage device 37, an output I/F 31, an input I/F 35, a read device 38, a bus 39, output equipment 41, and input equipment 42.

The bus 39 is connected with the CPU 32, the ROM 33, the RAM 36, the communication I/F 34, the storage device 37, the output I/F 31, the input I/F 35, and the read device 38. The read device 38 reads a portable recording medium. The output equipment 41 and the input equipment 42 are connected to the output I/F 31 and the input I/F 35, respectively.

Various types of storage devices such as a hard disk, a flash memory, and a magnetic disk may be utilized as the storage device 37. A program which causes the CPU 32 to function as the access control apparatus 1 is stored in the storage device 37 or the ROM 33. The RAM 36 includes a memory area in which data is temporarily stored.

The CPU 32 reads and executes the program for implementing the processing described in the embodiment and stored in, for example, the storage device 37.

The program for implementing the processing described in the embodiment may be received, for example, through a communication network 40 and the communication I/F 34 from a program provider and stored in the storage device 37. The program for implementing the processing described in the embodiment may be stored in a portable storage medium being sold and distributed. In this case, the portable storage medium may be set in the read device 38, the program stored in the portable storage medium may be installed in the storage device 37 and the installed program may be read and executed by the CPU 32. Various types of storage medium such as a compact disc ROM (CD-ROM), a flexible disk, an optical disk, an opto-magnetic disk, an integrated circuit (IC) card, and a universal serial bus (USB) memory device may be used as the portable storage medium. The program stored in the storage medium is read by the read device 38.

Devices such as a keyboard, a mouse, an electronic camera, a web camera, a microphone, a scanner, a sensor, and a tablet may be used as the input equipment 42. Devices such as a display, a printer, and a speaker may be used as the output equipment 41. The communication network 40 may be the Internet, a local area network (LAN), a wide area network (WAN), a dedicated line communication network, and a wired or wireless communication network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
receiving an access request for accessing first data;
reading consecutive blocks that start with a first block containing the first data from a first storage unit;
loading the consecutive blocks as corresponding consecutive pages into a memory area;
invalidating the consecutive blocks in the first storage unit; and
writing, before the loading, some of first pages held in the memory area into a contiguous empty area of the first storage unit in accordance with an access status of each of the first pages, the access status being whether each of the first pages has been accessed.

2. The non-transitory computer-readable recording medium according to claim 1, wherein
the writing includes:
writing one of the first pages into the first storage unit when the one of the first pages has been accessed.

3. The non-transitory computer-readable recording medium according to claim 1, wherein
the writing includes:
writing one of the first pages into a second storage unit different from the first storage unit when the one of the first pages has not been accessed.

4. An access control apparatus, comprising:
a processor configured to
receive an access request for accessing first data,
read consecutive blocks that start with a first block containing the first data from a first storage unit,
load the consecutive blocks as corresponding consecutive pages into a memory area,
invalidate the consecutive blocks in the first storage unit, and
write, before the loading, some of first pages held in the memory area into a contiguous empty area of the first storage unit in accordance with an access status of each of the first pages, the access status being whether each of the first pages has been accessed.

5. The access control apparatus according to claim 4, wherein
the processor is configured to
write one of the first pages into the first storage unit when the one of the first pages has been accessed.

6. The access control apparatus according to claim 4, wherein
the processor is configured to
write one of the first pages into a second storage unit different from the first storage unit when the one of the first pages has not been accessed.

7. An access control method, comprising:
receiving, by a computer, an access request for accessing first data;
reading consecutive blocks that start with a first block containing the first data from a first storage unit;
loading the consecutive blocks as corresponding consecutive pages into a memory area;
invalidating the consecutive blocks in the first storage unit; and
writing, before the loading, some of first pages held in the memory area into a contiguous empty area of the first storage unit in accordance with an access status of each of the first pages, the access status being whether each of the first pages has been accessed.

8. The access control method according to claim 7, wherein
the writing includes:
writing one of the first pages into the first storage unit when the one of the first pages has been accessed.

9. The access control method according to claim 7, wherein
the writing includes:
writing one of the first pages into a second storage unit different from the first storage unit when the one of the first pages has not been accessed.
